(19) United States
(12) Patent Application Publication
(10) Pub. No.: US 2017/0023201 A1
(43) Pub. Date: Jan. 26, 2017

(54) Lighting Device for Vehicle

(71) Applicant: Toshiba Lighting & Technology Corporation, Yokosuka-shi (JP)

(72) Inventors: Kiyokazu Hino, Yokosuka-shi (JP); Ryuji Tsuchiya, Yokosuka-shi (JP); Toshihiro Hatanaka, Yokosuka-shi (JP)

(73) Assignee: Toshiba Lighting & Technology Corporation, Yokosuka-shi (JP)

(21) Appl. No.: 15/207,786

(22) Filed: Jul. 12, 2016

(30) Foreign Application Priority Data
Jul. 24, 2015 (JP) 2015-146501

(51) Int. Cl. F21S 8/10; F21V 29/76; F21V 17/10; F21K 9/62; B60Q 1/00; F21K 9/64

(52) U.S. Cl. CPC F21S 48/328; B60Q 1/0088; F21K 9/64; F21V 17/104; F21V 17/101; F21K 9/62; F21V 29/763

(57) ABSTRACT

According to one embodiment, a lighting device for vehicle includes a socket including a base portion, and a first protrusion portion which protrudes from one face of the base portion; and a light emitting module which is provided at the first protrusion portion, and includes a light emitting element.

The socket contains a heat conductive resin of which heat conductivity is 7 W/(m•K) or more and 11 W/(m•K) or less.

When a maximum dimension of the base portion in a direction orthogonal to a center axis of the lighting device for vehicle is set to A1 (mm), a maximum dimension of the first protrusion portion in a direction orthogonal to the center axis is set to A2 (mm), and power which is applied to the light emitting module is set to W (watt), (A1-A2)/W becomes 1.0 (mm/W) or more and 6.5 (mm/W) or less.

### CROSS-REFERENCE TO RELATED APPLICATIONS

This application is based upon and claims the benefit of priority from Japanese Patent Application No. 2015-146501, filed on Jul. 24, 2015; the entire contents of which are incorporated herein by reference.

### FIELD

Embodiments described herein relate generally to a lighting device for vehicle.

### BACKGROUND

There is a lighting device for vehicle which is provided with a socket, and a light emitting module which includes a plurality of light emitting diodes (LED), and is provided in the socket.

In such a lighting device for vehicle, heat generated in the light emitting diode is mainly radiated to the outside through the socket. For this reason, the socket is formed of metal with high heat conductivity such as aluminum.

Here, a lightweight lighting device for vehicle is desired.

For this reason, as a material of the socket, a heat conductive resin containing a filler which is formed of carbon, or the like, is used.

However, when a socket formed of a heat conductive resin is simply adopted, a heat radiating performance becomes lower than that of a socket formed of metal such as aluminum.

For this reason, a technology in which a metallic member is provided between a light emitting module and a socket which is formed of a heat conductive resin in order to improve a heat radiating performance is proposed.

However, when a metallic member is provided, it causes an increase in weight and manufacturing cost.

Therefore, a development of a technology in which it is possible to improve the heat radiating performance of a socket itself which is formed of a heat conductive resin is desired.

### DESCRIPTION OF THE DRAWINGS

FIG. 1 is a schematic perspective view which illustrates a lighting device for vehicle according to one embodiment.

FIG. 2 is an exploded perspective view which schematically illustrates the lighting device for vehicle.

FIG. 3 is a schematic plan view of a light emitting module.

FIG. 4 is a schematic perspective view which illustrates protrusion portions.

FIG. 5 is a sectional view which is taken along line A-A in FIG. 4.

FIGS. 6A to 6C are schematic sectional views which illustrate sectional shapes of the protrusion portion.

### DETAILED DESCRIPTION

An exemplary embodiment according to one embodiment is a lighting device for vehicle which includes a socket including a base portion, and a first protrusion portion which protrudes from one face of the base portion; and a light emitting module which is provided at the first protrusion portion, and includes a light emitting element.

The socket contains a heat conductive resin of which heat conductivity is 7 W/(m•K) or more and 11 W/(m•K) or less.

When a maximum dimension of the base portion in a direction orthogonal to a center axis of the lighting device for vehicle is set to A1 (mm), a maximum dimension of the first protrusion portion in a direction orthogonal to the center axis is set to A2 (mm), and power which is applied to the light emitting module is set to W (watt), (A1-A2)/W becomes 1.0 (mm/W) or more and 6.5 (mm/W) or less.

In the lighting device for vehicle according to the embodiment, it is possible to improve a heat radiating performance, and realize light-weighting.

In the device, the socket may further include a fin which is provided on a side opposite to a side of the base portion on which the first protrusion portion is provided.

A distance from a face of the base portion on the side opposite to the side on which the first protrusion portion is provided to a top face of the fin may be set to 35 mm or less.

In this manner, it is possible to increase a heat radiating area, and prevent the fin from being wastefully heavy.

In the device, the maximum dimension A1 may be set to 40 mm or less.

In this manner, it is possible to increase a heat radiating area, and prevent the base portion from being wastefully heavy.

In the device, the power W may be set to 1.0 W or more and 6.0 W or less.

In this manner, it is possible to suppress wasteful heating in the light emitting module.

In the device, the socket may further include a second protrusion portion which is provided on a face of the base portion on the side opposite to the side on which the first protrusion portion is provided, and is bonded to the fin.

A distance from the face of the base portion on the side opposite to the side on which the first protrusion portion is provided to a top face of the second protrusion portion may be set to 4 mm or less.

In this manner, it is possible to cause air flow in the vicinity of the fin not to be disturbed. In addition, it is possible to increase a heat radiating area, and prevent the second protrusion portion from being wastefully heavy.

Hereinafter, one embodiment will be exemplified while referring to drawings. In addition, in each figure, the same constituent elements will be given the same reference numerals, and detailed descriptions will be appropriately omitted.

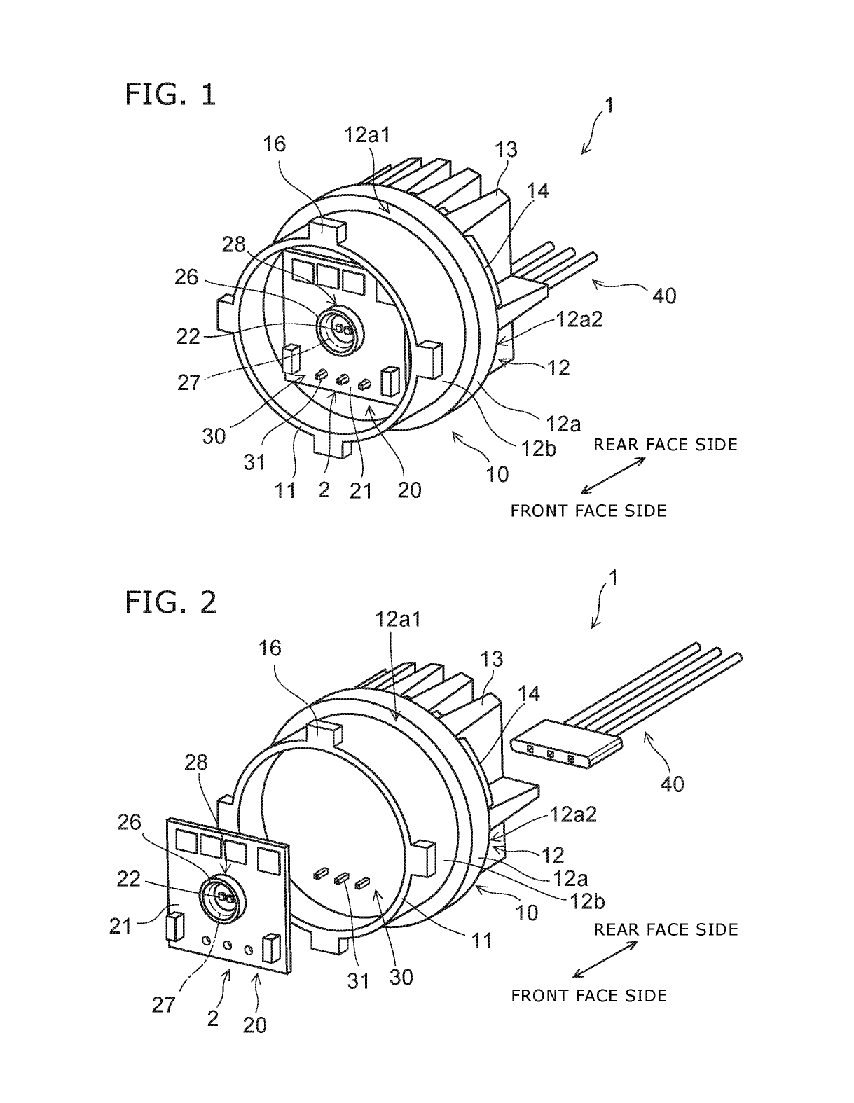

FIG. 1 is a schematic perspective view which illustrates a lighting device for vehicle 1 according to the embodiment.

FIG. 2 is an exploded perspective view which schematically illustrates the lighting device for vehicle 1.

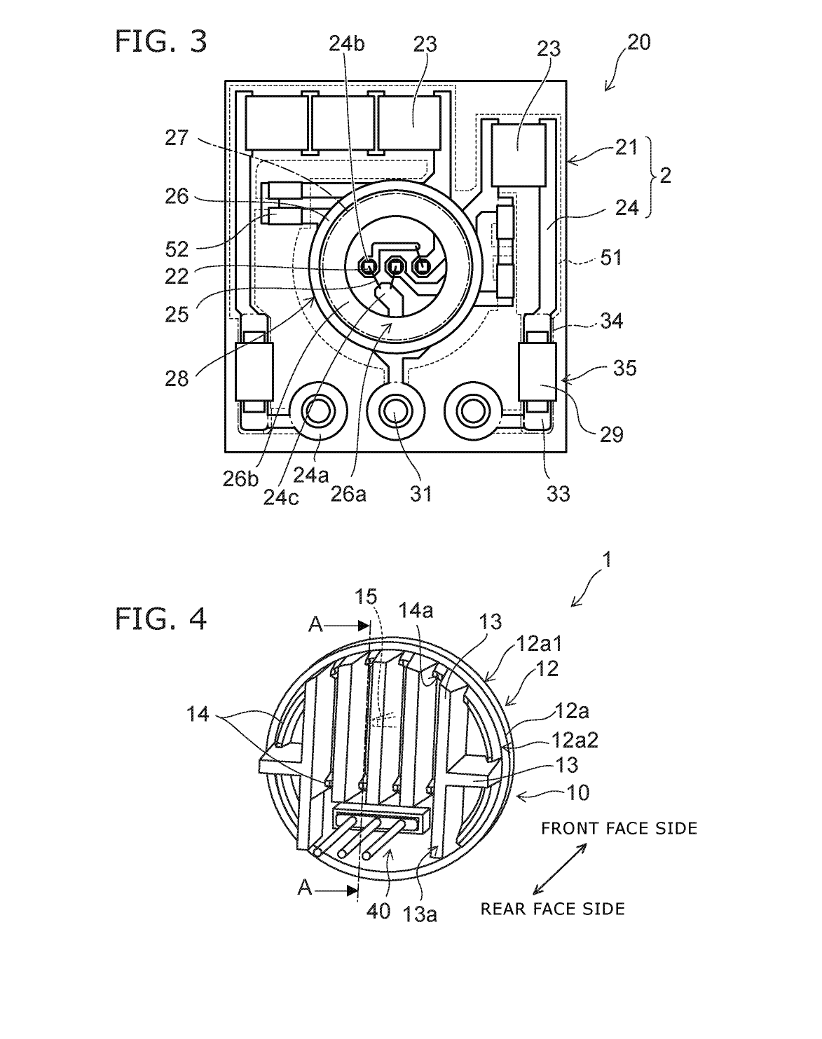

FIG. 3 is a schematic plan view of a light emitting module 20.

As illustrated in FIGS. 1 and 2, a socket 10, the light emitting module 20, a power feeding unit 30, and a connector 40 are provided in the lighting device for vehicle 1. An accommodation unit 11, a flange portion 12, a fin 13, a protrusion portion 14 (corresponding to an example of second protrusion portion), a protrusion portion 15 (corresponding to an example of third protrusion portion), and an attaching unit 16 are provided in the socket 10. The accommodation unit 11 is formed in a cylindrical shape, and protrudes from a protrusion portion 12b (corresponding to an example of first protrusion portion) of the flange portion 12. The light emitting module 20 is provided inside the accommodation unit 11, and on the protrusion portion 12b of the flange portion 12. In addition, a power feeding terminal 31 of a power feeding unit 30 protrudes to the inside of the accommodation unit 11.

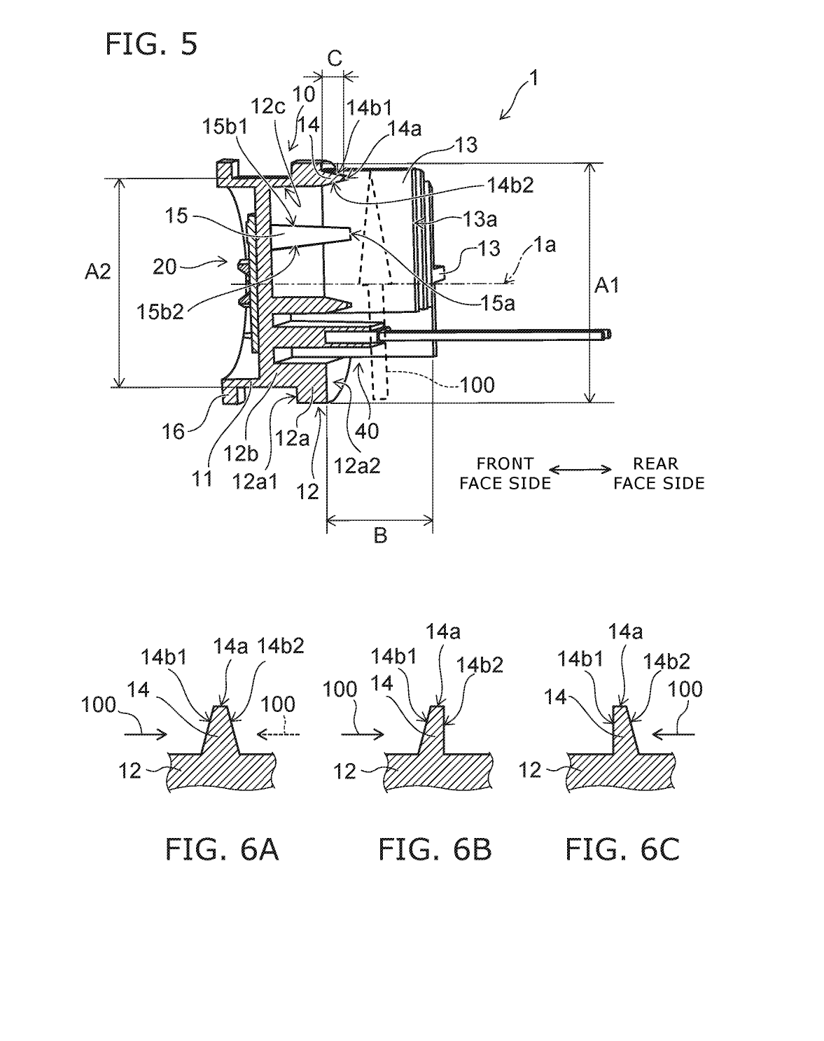

The flange portion 12 includes a base portion 12a, the protrusion portion 12b, and a recessed portion 12c (refer to FIG. 5).

The base portion 12a is formed in a disk shape.

The protrusion portion 12b protrudes from one face of the base portion 12a. The protrusion portion 12b is provided on a face 12a1 of the base portion 12a. The face 12a1 of the base portion 12a faces a front face side of the lighting device for vehicle 1.

The light emitting module 20 which includes a light emitting element 22 is provided on the protrusion portion 12b.

A face 12a2 of the base portion 12a is provided in the recessed portion 12c (refer to FIG. 5). The face 12a2 of the base portion 12a faces a rear face side of the lighting device for vehicle 1.

That is, the recessed portion 12c is provided on a side opposite to a side on which the light emitting module 20 is provided.

In addition, the fin 13, and a protrusion portion 14 are provided on the face 12a2 of the base portion 12a.

The fin 13 protrudes from the face 12a2 of the base portion 12a. A plurality of the fins 13 are provided. The plurality of fins 13 are formed in a plate shape, and function as heat radiating fins.

The protrusion portion 14 protrudes from the face 12a2 of the base portion 12a, and is bonded to the fin 13.

The protrusion portion 15 is provided inside the recessed portion 12c, and a tip end thereof protrudes from the face 12a2 of the base portion 12a.

That is, the protrusion portion 15 is provided inside the recessed portion 12c, and protrudes from the face 12a2 of the base portion 12a on a side opposite to the side on which the light emitting module 20 is provided.

The protrusion portion 15 is bonded to the fin 13.

In addition, the protrusion portion 12b, the recessed portion 12c, the protrusion portion 14, and the protrusion portion 15 will be described in detail later.

It is also possible to integrally mold the accommodation unit 11, the flange portion 12, the fin 13, the protrusion portion 14, and the protrusion portion 15, and bond these elements using an adhesive, or the like.

However, when the accommodation unit 11, the flange portion 12, the fin 13, the protrusion portion 14, and the protrusion portion 15 are integrally molded, it is possible to improve a heat radiating performance, and resistance against an external force, and to reduce a manufacturing cost.

The attaching unit 16 is provided on a side wall of the accommodation unit 11. The attaching unit 16 protrudes toward the outside of the lighting device for vehicle 1.

A plurality of the attaching units 16 are provided.

The attaching unit 16 is inserted into a groove portion which is provided in a lighting tool for vehicle when mounting the lighting device for vehicle 1 on the lighting tool for vehicle. In addition, the lighting device for vehicle 1 is held in the lighting tool for vehicle when rotating the lighting device for vehicle 1.

That is, the attaching unit 16 is used as a twist-lock.

Here, when a current flows in the light emitting element 22, a control element 23, or the like, heat is generated.

When a temperature of the light emitting element 22 excessively increases due to the generated heat, there is a concern that a decrease in light flux, a disconnection of wiring 25, a separation of the light emitting element 22, or the like, may occur.

For this reason, it is necessary to efficiently radiate the generated heat to the outside of the lighting device for vehicle 1.

In this case, the generated heat is radiated to the outside mainly through the socket 10.

When a material of the socket 10 is metal with high heat conductivity such as aluminum, it is possible to efficiently radiate the generated heat to the outside of the lighting device for vehicle 1.

However, there is a problem in that the lighting device for vehicle 1 becomes heavy since metal has high specific gravity. In contrast to this, when a material of the socket 10 is a heat conductive resin, it is possible to make the lighting device for vehicle 1 lightweight. However, when adopting the heat conductive resin as a material of the socket 10, a heat radiating performance decreases compared to a socket formed of metal.

In this case, when increasing an amount of filler contained in a heat conductive resin, heat conductivity can be increased, and accordingly, it is possible to suppress deterioration in heat radiating performance.

However, when increasing an amount of filler contained in the heat conductive resin, there is a problem in that the heat conductive resin becomes fragile, and machining becomes difficult.

For this reason, when considering a heat radiating performance and processability, it is preferable to set heat conductivity of the heat conductive resin to 7 W (m•K) or more and 11 W (m•K) or less.

In addition, the heat conductive resin can be a resin in which filler formed of carbon with high heat conductivity, aluminum oxide, or the like, is mixed in a resin of, for example, polyethylene terephthalate (PET), nylon, or the like.

As illustrated in FIG. 3, a substrate 2, the light emitting element 22, the control element 23, the wiring 25, a frame portion 26, a sealing portion 27, a joint portion 28, a control element 29, a cover portion 51, a metal film 34, and a control element 52 are provided in the light emitting module 20.

In addition, a base body 21, and a wiring pattern 24 are provided on the substrate 2.

The base body 21 is provided inside the accommodation unit 11 of the socket 10, and on the protrusion portion 12b of the flange portion 12.

The base body 21 is formed in a plate shape, and is provided with the wiring pattern 24 on the surface thereof.

The base body 21 can be formed of, for example, ceramic of aluminum oxide, aluminum nitride, or the like.

In addition, the base body 21 may have a single-layer structure, or a multi-layer structure.

The wiring pattern 24 is provided at least on one surface of the base body 21.

The wiring pattern 24 can be provided on both faces of the base body 21; however, it is preferable to provide the wiring pattern on one face of the base body 21, in order to reduce a manufacturing cost.

An input terminal 24a is provided in the wiring pattern 24.

A plurality of the input terminals 24a are provided. The power feeding terminal 31 of the power feeding unit 30 is electrically connected to the input terminal 24a. For this reason, the light emitting element 22 is electrically connected to the power feeding unit 30 through the wiring pattern 24.

The wiring pattern 24 can be formed of a material of which a main component is silver. The wiring pattern 24 can be formed of, for example, silver, or a silver alloy. However, a material of the wiring pattern 24 is not limited to the material of which a main component is silver. It is also possible to form the wiring pattern 24 using, for example, a material of which a main component is copper, or the like.

It is possible to form the wiring pattern 24 using, for example, a screen printing method, and a baking method.

A plurality of the light emitting elements 22 are provided on the wiring pattern 24.

The light emitting element 22 can include an electrode (not illustrated) on a face (top face) on a side opposite to the side on which the light emitting element is provided in the wiring pattern 24. In addition, an electrode (not illustrated) may be provided on a face (lower face) on a side on which the light emitting element is provided in the wiring pattern 24, and the face (top face) on the side opposite to the side on which the light emitting element is provided in the wiring pattern 24, and may be provided on only one face thereof.

An electrode (not illustrated) which is provided on the lower face of the light emitting element 22 is electrically connected to a mounting pad 24b which is provided in the wiring pattern 24 through a conductive thermosetting material such as silver paste. An electrode (not illustrated) which is provided on the top face of the light emitting element 22 is electrically connected to a wiring pad 24c which is provided in the wiring pattern 24 through the wiring 25.

The light emitting element 22 can be set to, for example, a light emitting diode, an organic light emitting diode, a laser diode, or the like.

The top face of the light emitting element 22 as a light emission surface of light faces the front face side of the lighting device for vehicle 1. The light emitting element 22 mainly emits light toward the front face side of the lighting device for vehicle 1. The number, a size, an arrangement, or the like, of the light emitting element 22 is not limited to exemplifications, and can be appropriately changed according to a size, a use, or the like, of the lighting device for vehicle 1.

The control element 23 is provided on the wiring pattern 24.

The control element 23 controls a current which flows in the light emitting element 22.

Since there is a variation in forward voltage characteristics of the light emitting element 22, when setting an application voltage between an anode terminal and a ground terminal to be constant, a variation occurs in brightness (light flux, luminance, intensity of light, illumination) of the light emitting element 22. For this reason, a value of a current which flows in the light emitting element 22 is set so as to be within a predetermined range using the control element 23, so that brightness of the light emitting element 22 is within a predetermined range.

The control element 23 can be set to, for example, a resistor. The control element 23 can be set to, for example, a surface-mounted resistor, a resistor including a lead wire (metal oxide film resistor), a film-shaped resistor which is formed by using a screen printing method and a baking method, and the like.

In addition, the control element 23 illustrated in FIG. 3 is a film-shaped resistor.

In addition, it is possible to set a value of a current which flows in the light emitting element 22 to be within a predetermined range by changing a resistance value of the control element 23.

For example, when the control element 23 is a film-shaped resistor, an elimination portion (not illustrated) is formed, by eliminating a part of the control element 23. In addition, a resistance value of the control element 23 is changed by using a size, the number, or the like, of the elimination portion. In this case, when a part of the control element 23 is eliminated, the resistance value increases. Eliminating of a part of the control element 23 can be performed by radiating laser light to the control element 23.

The number, a size, arrangements, or the like, of the control element 23 is not limited to the exemplifications, and can be appropriately changed according to the number, specifications, or the like, of the light emitting element 22.

The wiring 25 electrically connects an electrode (not illustrated) which is provided on the top face of the light emitting element 22 and the wiring pad 24c which is provided in the wiring pattern 24.

The wiring 25 can be set to, for example, a wire of which a main component is gold. However, a material of the wiring 25 is not limited to the material of which a main component is gold. A material of the wiring 25 may be a material, for example, of which a main component is copper, aluminum, or the like.

The wiring 25 is electrically connected to the electrode (not illustrated) provided on the top face of the light emitting element 22, and the wiring pad 24c which is provided in the wiring pattern 24, using ultrasonic welding or heat welding, for example. The wiring 25 can be electrically connected to the electrode (not illustrated) provided on the top face of the light emitting element 22, and the wiring pad 24c which is provided in the wiring pattern 24 using a wire bonding method, for example.

The frame portion 26 is provided on the base body 21 so as to surround the plurality of light emitting elements 22. The frame portion 26 is formed in an annular shape, for example, and the plurality of light emitting elements 22 are arranged at a center portion 26a.

The frame portion 26 can be formed of, for example, a resin of polybutylene terephthalate (PBT), polycarbonate (PC), or the like, or ceramic, or the like.

In addition, when a material of the frame portion 26 is set to a resin, it is possible to improve reflectivity with respect to light emitted from the light emitting element 22 by mixing particles of titanium oxide, or the like.

In addition, particles which are formed of a material with high reflectivity with respect to light emitted from the light emitting element 22 may be mixed, without limiting to particles of titanium oxide.

In addition, the frame portion 26 can be formed of a white resin, for example.

A side wall face 26b of the frame portion 26 on the center portion 26a side is an inclined face. Part of light emitted from the light emitting element 22 is reflected on the side wall face 26b of the frame portion 26, and is emitted toward the front face side of the lighting device for vehicle 1.

In addition, light which is part of light emitted toward the front face side of the lighting device for vehicle 1 from the light emitting element 22, and is totally reflected on a top face of the sealing portion 27 (interface between sealing portion 27 and ambient air) is reflected on the side wall face 26b of the frame portion 26 on the center portion 26a side, and is reemitted toward the front face side of the lighting device for vehicle 1.

That is, the frame portion 26 has a function of regulating a formation range of the sealing portion 27, and functions as a reflector. In addition, a form of the frame portion 26 can be appropriately changed without being limited to exemplifications.

The sealing portion 27 is provided at the center portion 26a of the frame portion 26. The sealing portion 27 is provided so as to cover the inside of the frame portion 26. That is, the sealing portion 27 is provided inside the frame portion 26, and covers the light emitting element 22, the wiring 25, or the like.

The sealing portion 27 is formed of a material with light transmittance. The sealing portion 27 can be formed of, for example, a silicone resin, or the like.

The sealing portion 27 can be formed, for example, by filling the center portion 26a of the frame portion 26 with a resin. Filling of a resin can be performed, for example, by using a quantitative liquid ejecting device such as a dispenser.

When a resin is filled in the center portion 26a of the frame portion 26, it is possible to suppress a mechanical contact from the outside with respect to the light emitting element 22, the wiring pattern 24, the wiring 25, and the like, which are arranged at the center portion 26a of the frame portion 26. In addition, it is possible to prevent moisture, gas, or the like, from attaching to the light emitting element 22, and the wiring pattern 24, the wiring 25, and the like, which are arranged at the center portion 26a of the frame portion 26. For this reason, it is possible to improve reliability of the lighting device for vehicle 1.

In addition, it is possible to contain a phosphor in the sealing portion 27. The phosphor can be, for example, an yttrium-aluminum-garnet phosphor (YAG-based phosphor).

For example, when the light emitting element 22 is a blue light emitting diode, and the phosphor is the YAG-based phosphor, the YAG-based phosphor is exited due to blue light which is emitted from the light emitting element 22, and yellow fluorescence is radiated from the YAG-based phosphor. In addition, white light is emitted from the lighting device for vehicle 1 when the blue light and the yellow light are mixed together. In addition, a type of the phosphor, or a type of the light emitting element 22 is not limited to exemplifications. The type of the phosphor, or the type of the light emitting element 22 can be appropriately changed so as to obtain a desired luminescent color according to a use, or the like, of the lighting device for vehicle 1.

The joint portion 28 joints the frame portion 26 and the base body 21.

The joint portion 28 is formed in a film shape, and is provided between the frame portion 26 and the base body 21.

The joint portion 28 can be formed by hardening a silicone-based adhesive or an epoxy-based adhesive, for example.

The control element 29 is provided on the wiring pattern 24 through a soldering portion 33. That is, the control element 29 is soldered on the wiring pattern 24.

The control element 29 is provided so that a reverse voltage is not applied to the light emitting element 22, and a pulse noise from an opposite direction is not applied to the light emitting element 22.

The control element 29 can be set to a diode, for example. The control element 29 can be set to, for example, a surface-mounted diode, a diode including a lead wire, or the like.

The control element 29 illustrated in FIG. 3 is the surface-mounted diode.

The control element 52 is provided on the wiring pattern 24.

The control element 52 is provided in order to detect a disconnection of the light emitting diode, prevent erroneous lighting, or the like. The control element 52 is a pull-down resistor.

The control element 52 can be set to a film-shaped resistor which is formed by using a screen printing method and a baking method.

The control element 52 can be set to a film-shaped resistor which is formed of ruthenium oxide, for example.

The cover portion 51 is provided so as to cover a part of the wiring pattern 24, the control element 23 as the film-shaped resistor, and the control element 52 as the film-shaped resistor.

In addition, the cover portion 51 is not provided in a region in which the control element 29 and the light emitting element 22 are provided, a region in which the wiring 25 is connected, and a region in which the power feeding terminal 31 is connected.

For example, the cover portion 51 does not cover a region 35 in which the control element 29 is soldered.

The cover portion 51 is provided so as to prevent moisture, gas, or the like, from coming into contact with the wiring pattern 24, the control element 23, and the control element 52, and to secure electric insulation. A glass material can be contained in the cover portion 51.

The metal film 34 is provided in the region 35 in which soldering is performed, and covers the wiring pattern 24. As described above, the wiring pattern 24 is formed of, for example, a material of which a main component is silver. For this reason, there is a case in which migration occurs due to an electrical connection under a high humidity condition. For example, there is a case in which short circuit may occur between soldering portions 33 which stand face to face with each other, or the like.

For this reason, the metal film 34 for covering the wiring pattern 24 is provided in order to suppress migration, or improve solder wettability.

In addition, when the wiring pattern 24 is formed of a material of which a main component is copper, for example, oxidization or a reaction with sulfur becomes quick under a high temperature condition, or under an atmosphere with many sulfur components, and there is a case in which solder wettability deteriorates. For this reason, also when the wiring pattern 24 is formed of a material of which a main component is copper, it is preferable to provide the metal film 34 which covers the wiring pattern 24.

The metal film 34 can be set to a laminated film including at least a film formed of nickel, and a film formed of gold. The metal film 34 can be set to a laminated film in which the film formed of nickel, and the film formed of gold are laminated in this order, and a laminated film in which the film formed of nickel, a film formed of palladium, and the film formed of gold are laminated in this order, for example.

The metal film 34 can be formed in the region 35 in which soldering is performed, using an electroless plating method, for example.

A plurality of the power feeding terminals 31 are provided in the power feeding unit 30.

The plurality of power feeding terminals 31 extend inside the accommodation unit 11 and the flange portion 12. One end portion of the plurality of power feeding terminals 31 protrudes from the protrusion portion 12b of the flange portion 12, and is electrically connected to the input terminal 24a of the wiring pattern 24. The other end portion of the plurality of power feeding terminals 31 is exposed from the socket 10 on a rear face side of the lighting device for vehicle 1.

In addition, the number, an arrangement, a form, or the like, of the power feeding terminal 31 is not limited to exemplifications, and can be appropriately changed.

In addition, the power feeding unit 30 can include a substrate (not illustrated), or a circuit component such as a capacitor, or a resistor. In addition, the substrate (not illustrated), or the circuit component can be provided, for example, inside the accommodation unit 11, inside the flange portion 12, or the like.

The connector 40 is fitted into an end portion of the plurality of power feeding terminals 31 which are exposed from the socket 10.

A power supply (not illustrated), or the like, is electrically connected to the connector 40.

For this reason, the power supply (not illustrated), or the like, and the light emitting element 22 are electrically connected when the connector 40 is fitted into the end portion of the power feeding terminal 31.

The connector 40 can be bonded to elements on the socket 10 side using, for example, an adhesive, or the like.

Subsequently, a heat radiating performance of the lighting device for vehicle 1 will be further described.

First, the protrusion portion 12b, the recessed portion 12c, the protrusion portion 14, and the protrusion portion 15 will be described.

As described above, when increasing an amount of filler contained in a heat conductive resin, it is possible to improve a heat radiating performance; however, the heat conductive resin becomes fragile, and resistance against an external force (mechanical strength) decreases.

In addition, the fin 13 is formed in a plate shape in order to cause air to easily flow between fins 13. In addition, when the fin 13 and the flange portion 12 are integrally molded, it is necessary to make a thickness of the fin 13 thin to some extent in order to suppress a sink mark (recession, deformation) at a time of molding. For this reason, when the fin 13 is molded by using a heat conductive resin, resistance against an external force of the fin 13 decreases, and a fracture, or the like, easily occurs at a bonding portion between the fin 13 and the flange portion 12 (base of fin 13), or the like.

Therefore, according to the embodiment, the protrusion portion 14 which is bonded to the fin 13 and the flange portion 12 is provided.

In addition, as described above, the light emitting module 20 is provided inside the accommodation unit 11.

For this reason, light emitted from the light emitting element 22 is easily blocked by the accommodation unit 11, or the attaching unit 16 which is provided on the side wall of the accommodation unit 11.

In this case, when an attaching position of the light emitting module 20 is set to be close to the front face side of the lighting device for vehicle 1, it is possible to prevent light emitted from the light emitting element 22 from being blocked by the accommodation unit 11 or the attaching unit 16.

For this reason, the protrusion portion 12b which protrudes toward the front face side of the lighting device for vehicle 1 from the base portion 12a is provided, and the light emitting module 20 is provided in the protrusion portion 12b. That is, the attaching position of the light emitting module 20 is set to be close to the front face side of the lighting device for vehicle 1, by providing the protrusion portion 12b.

However, when the protrusion portion 12b is provided, the flange portion 12 becomes thick as much as the protrusion portion 12b, and it causes an increase in weight, in material cost, or the like. For this reason, a weight or a material cost is suppressed by providing the recessed portion 12c on the face 12a2 of the base portion 12a. The recessed portion 12c is open to the face 12a2 of the base portion 12a.

However, since air rarely flows inside the recessed portion 12c, there is a concern that heat may stay inside the recessed portion 12c, and a heat radiating performance may deteriorate.

Therefore, according to the embodiment, the protrusion portion 15 which is bonded to the fin 13 is provided inside the recessed portion 12c.

FIG. 4 is a schematic perspective view which illustrates the protrusion portions 14 and 15.

In addition, FIG. 4 is a figure in which the lighting device for vehicle 1 is viewed from the rear face side (side opposite to side on which light emitting module 20 is provided).

FIG. 5 is a sectional view which is taken along line A-A in FIG. 4.

FIGS. 6A to 6C are schematic sectional views which illustrate sectional shapes of the protrusion portion 14.

As illustrated in FIGS. 4 and 5, the protrusion portion 14 protrudes from the face 12a2 of the base portion 12a, and is bonded to the fin 13.

In this case, the protrusion portion 14 can be provided between one fin 13 and another fin 13 which is close to the one fin 13.

In addition, the protrusion portion 14 can be bonded to at least any one of the one fin 13 and another fin 13.

That is, the protrusion portion 14 is bonded to a base side of the fin 13.

For this reason, it is possible to improve resistance against an external force of the fin 13.

In this case, a direction in which the fin 13 extends, and a direction in which the protrusion portion 14 extends can be crossed. In this manner, it is possible to further improve resistance against an external force of the fin 13.

In addition, the protrusion portion 14 is bonded to the flange portion 12 in which the light emitting module 20 as a heat source is provided.

For this reason, the protrusion portion 14 also functions as a heat radiating fin.

When the protrusion portion 14 is provided, it is possible to improve a heat radiating performance.

Here, air flows in the vicinity of the fin 13 due to natural convection, or the like. For this reason, when air flow is disturbed by the protrusion portion 14, there is a concern that an improvement of a heat radiating performance may not be obtained.

In this case, when the protrusion portion 14 is provided between the fins 13, air flow between the fins 13 is easily disturbed.

Therefore, a position of a top face 14a of the protrusion portion 14 is located on the flange portion 12 side (base portion 12a side), rather than a position of a top face 13a of the fin 13. That is, a height of the protrusion portion 14 is set to be lower than a height of the fin 13.

In this manner, it is possible to prevent air flow in the vicinity of the fin 13 from being disturbed even when the protrusion portion 14 is provided.

In addition, as illustrated in FIG. 5, the protrusion portion 14 includes a face 14b1 (corresponding to an example of first face) which intersects the fin 13, and a face 14b2 (corresponding to an example of second face) which stands face to face with the face 14b1.

At least any one of the face 14b1 and the face 14b2 is inclined so that a distance between the face 14b1 and the face 14b2 becomes gradually short toward the top face 14a of the protrusion portion 14.

That is, at least any one of the face 14b1 and the face 14b2 is an inclined face.

In this case, as illustrated in FIG. 6A, it is possible to set both the face 14b1 and the face 14b2 to inclined faces.

When both the face 14b1 and the face 14b2 are set to inclined faces, inclining directions are set to be opposite to each other.

In addition, as illustrated in FIGS. 6B and 6C, it is also possible to set the face 14b1 or the face 14b2 to an inclined face.

In addition, when a plurality of the protrusion portions 14 are provided, it is possible to set respective faces 14b1 of the plurality of protrusion portions 14 so as to be inclined in the same direction. It is possible to set respective faces 14b2 of the plurality of protrusion portions 14 so as to be inclined in the same direction.

When an inclined face is provided, it is possible to prevent turbulence from occurring in air flow.

For this reason, a heat radiating performance can be improved, since it is possible to make air flow smooth.

In this case, as illustrated in FIGS. 6B and 6C, it is possible to set a face on the upstream side in an air flow direction 100 to an inclined face.

In addition, the air flow direction 100 is influenced by an attaching form of the lighting device for vehicle 1, a circumstance in which the lighting device for vehicle 1 is attached, or the like.

For this reason, as illustrated in FIG. 6A, when two faces which stand face to face with each other (faces 14b1 and 14b2) are set to inclined faces, and inclining directions are set to be opposite to each other, even when it is not possible to know the air flow direction 100 in advance, or the air flow direction 100 is changed, it is possible to correspond to the case.

In addition, as illustrated in FIGS. 4 and 5, the protrusion portion 15 is provided inside the recessed portion 12c.

In addition, a tip end of the protrusion portion 15 protrudes from the face 12a2 of the base portion 12a. The protrusion portion 15 is bonded to the fin 13.

In this case, it is possible to provide the protrusion portion 15 between one fin 13 and another fin 13 which is close to the one fin 13.

In addition, the protrusion portion 15 can be bonded to at least any one of the one fin 13 and another fin 13.

That is, the protrusion portion 15 is bonded to the base side of the fin 13.

For this reason, it is possible to improve resistance against an external force of the fin 13.

In this case, a direction in which the fin 13 extends, and a direction in which the protrusion portion 15 extends can be crossed. In this manner, it is possible to further improve resistance against an external force of the fin 13.

As described above, since air rarely flows inside the recessed portion 12c, heat easily stays inside the recessed portion 12c.

In this case, when the protrusion portion 15 is provided inside the recessed portion 12c, and the protrusion portion 15 is bonded to the fin 13, it is possible to release heat in the inside of the recessed portion 12c to the fin 13.

In this manner, the protrusion portion 15 also functions as a heat transmission unit and a heat radiating fin.

For this reason, when the protrusion portion 15 is provided, it is possible to improve a heat radiating performance since heat in the inside of the recessed portion 12c can be released.

In addition, similarly to the above described protrusion portion 14, a position of a top face 15a of the protrusion portion 15 is located on the flange portion 12 side, rather than a position of the top face 13a of the fin 13.

In this manner, it is possible to prevent air flow in the vicinity of the fin 13 from being disturbed, even when the protrusion portion 15 is provided.

In this case, the position of the top face 15a of the protrusion portion 15 in the protruding direction (height direction) of the protrusion portion 15 can be set so as to be the same as the position of the top face 14a of the protrusion portion 14.

In this manner, it is possible to prevent turbulence from occurring in air flow.

For this reason, a heat radiating performance can be further improved, since it is possible to make air flow smooth.

In addition, as illustrated in FIG. 5, the protrusion portion 15 includes a face 15b1 which intersects the fin 13, and a face 15b2 which stands face to face with the face 15b1.

At least any one of the face 15b1 and the face 15b2 is inclined so that a distance between the face 15b1 and the face 15b2 becomes gradually short toward the top face 15a of the protrusion portion 15.

That is, at least any one of the face 15b1 and the face 15b2 is an inclined face.

In addition, similarly to the protrusion portion 14 which is illustrated in FIG. 6A, it is possible to set both the face 15b1 and the face 15b2 to inclined faces.

When both the face 15b1 and the face 15b2 are set to inclined faces, inclining directions are set to be opposite to each other.

In addition, similarly to the protrusion portions 14 which are illustrated in FIGS. 6B and 6C, it is also possible to set the face 15b1 or the face 15b2 to an inclined face.

In addition, when a plurality of the protrusion portions 15 are provided, it is possible to set respective faces 15b1 of the plurality of protrusion portions 15 so as to be inclined in the same direction. It is possible to set respective faces 15b2 of the plurality of protrusion portions 15 so as to be inclined in the same direction.

When an inclined face is provided, it is possible to prevent turbulence from occurring in air flow.

For this reason, a heat radiating performance can be improved, since it is possible to make air flow smooth.

In this case, similarly to the protrusion portions 14 which are illustrated in FIGS. 6B and 6C, it is possible to set a face on the upstream side in the air flow direction 100 to an inclined face.

In addition, the air flow direction 100 is influenced by an attaching form of the lighting device for vehicle 1, a circumstance in which the lighting device for vehicle 1 is attached, or the like.

For this reason, similarly to the protrusion portion 14 which is illustrated in FIG. 6A, when two faces which stand face to face with each other (faces 15b1 and 15b2) are set to inclined faces, and inclining directions are set to be opposite to each other, even when it is not possible to know the air flow direction 100 in advance, or the air flow direction 100 is changed, it is possible to correspond to the case.

Subsequently, the base portion 12a, the protrusion portion 12b, the fin 13, and the protrusion portion 14 will be further described.

First, a heat radiating performance of the base portion 12a and the protrusion portion 12b will be described.

According to a knowledge which the invertors obtained, most of heat generated in the light emitting element 22, or the like, is radiated to the outside from the base portion 12a of the flange portion 12 which is close to the light emitting module 20 as the heat source, and comes into contact with a lighting tool for vehicle, or the like.

In addition, the protrusion portion 12b between the light emitting module 20 and the base portion 12a becomes a heat transmission unit.

In addition, when power W which is applied to the light emitting module 20 increases, a heating value which is generated increases.

For this reason, the maximum dimension (dimension of diameter when base portion 12a is columnar shape) A1 (mm) of the base portion 12a in a direction orthogonal to the center axis 1a of the lighting device for vehicle 1 (refer to FIG. 5), the maximum dimension (dimension of diameter when protrusion portion 12b is columnar shape) A2 (mm) of the protrusion portion 12b in a direction orthogonal to the center axis 1a of the lighting device for vehicle 1 (refer to FIG. 5), and the power W (watt) which is applied to the light emitting module 20 are involved with a heat radiating performance.

According to a knowledge which the invertors obtained, when (A1-A2)/W is set to a predetermined value or more, it is possible to improve a heat radiating performance.

In this case, the maximum dimension A2 of the protrusion portion 12b is regulated by a dimension, or the like, of an attaching hole which is provided in a lighting tool for vehicle. In addition, the power W which is applied to the light emitting module 20 is regulated by specifications or the number of the light emitting elements 22.

For this reason, virtually, the maximum dimension A1 of the base portion 12a has the greatest influence on an improvement of a heat radiating performance.

That is, when the maximum dimension A1 of the base portion 12a is set to be large, it is possible to improve a heat radiating performance.

However, as described above, it is preferable to set heat conductivity of a heat conductive resin to 11 W/(m•K) or less.

For this reason, heat which is transmitted decreases, and there is a small temperature rise, when being far from the light emitting module 20 as the heat source.

That is, even when the maximum dimension A1 of the base portion 12a is set to be large more than necessary, since a temperature in a peripheral edge region of the base portion 12a is not changed much, an improvement of a heat radiating performance is not expected.

Meanwhile, when the maximum dimension A1 of the base portion 12a is set to be excessively large, there is a concern that light-weighting of the lighting device for vehicle 1 may not be realized.

According to a knowledge which the inventors obtained, when the maximum dimension A1 of the base portion 12a is set to 40 mm or less, it is possible to improve a heat radiating performance, and realize light-weighting.

Table 1 is a table for denoting an evaluation result related to (A1-A2)/W.

TABLE 1

| | HEAT RADIATING | |
|---|---|---|
| (A1 − A2)/W | PERFORMANCE | LIGHT-WEIGHTING |
| 0 | X | ◯ |
| 1.0 | ◯ | ◯ |
| 2.0 | ◯ | ◯ |
| 3.0 | ◯ | ◯ |
| 4.0 | ◯ | ◯ |
| 5.0 | ◯ | ◯ |
| 6.0 | ◯ | ◯ |
| 6.5 | ◯ | ◯ |
| 7.0 | ◯ | X |
| 8.0 | ◯ | X |

In addition, Table 1 denotes a result which is obtained by acquiring a heat radiation amount and a weight of the socket 10 through a simulation, and determining whether a heat radiating performance and light-weighting are good or bad, using a predetermined threshold value.

In this case, heat conductivity of a heat conductive resin is set to 7 W/(m•K) or more and 11 W/(m•K) or less.

The power W which is applied to the light emitting module 20 is set to 1.0 W or more and 6.0 W or less.

The maximum dimension A1 of the base portion 12a is set to 40 mm or less.

In addition, an evaluation of (A1-A2)/W is performed by changing the maximum dimension A1 of the base portion 12a, and the maximum dimension A2 of the protrusion portion 12b.

In addition, (A1-A2)/W=0 is obtained when A1=A2.

As is understood from the Table 1, when (A1-A2)/W is set to 1.0 (mm/W) or more and 6.5 (mm/W) or less, it is possible to improve a heat radiating performance, and realize light-weighting.

In addition, when heat conductivity of a heat conductive resin is 7 W/(m•K) or more and 11 W/(m•K) or less, there is no change in an optimal range of (A1-A2)/W.

Subsequently, a heat radiating performance of the fin 13 will be described.

As described above, the fin 13 functions as a heat radiating fin.

For this reason, when a distance B (refer to FIG. 5) from the face 12a2 of the base portion 12a on the side opposite to the side on which the protrusion portion 12b is provided to the top face 13a of the fin 13 is set to be large, it is possible to improve a heat radiating performance.

However, as described above, it is preferable to set heat conductivity of a heat conductive resin to 11 W/(m•K) or less.

For this reason, heat which is transmitted decreases, and there is a small temperature rise, when being far from the light emitting module 20 as the heat source.

That is, even when the distance B to the top face 13a of the fin 13 (protruding length of fin 13) is set to be large more than necessary, since a temperature in a tip end region of the fin 13 is not changed much, an improvement of a heat radiating performance is not expected.

Meanwhile, when the distance B to the top face 13a of the fin 13 is set to be excessively large, there is a concern that light-weighting of the lighting device for vehicle 1 may not be realized.

According to a knowledge which the inventors obtained, when the distance B to the top face 13a of the fin 13 is set to 35 mm or less, it is possible to improve a heat radiating performance, and realize light-weighting.

Subsequently, a heat radiating performance of the protrusion portion 14 will be described.

As described above, the protrusion portion 14 functions as a heat radiating fin.

For this reason, when a distance C (mm) from the face 12a2 of the base portion 12a on the side opposite to the side on which the protrusion portion 12b is provided to the top face 14a of the protrusion portion 14 (refer to FIG. 5) is set to be large, it is possible to improve a heat radiating performance.

However, as described above, it is preferable to set heat conductivity of a heat conductive resin to 11 W/(m•K) or less.

For this reason, heat which is transmitted decreases, and there is a small temperature rise, when being far from the light emitting module 20 as the heat source.

That is, even when the distance C (protruding length of protrusion portion 14) to the top face 14a of the protrusion portion 14 is set to be large more than necessary, since a temperature in a tip end region of the protrusion portion 14 is not changed much, an improvement of a heat radiating performance is not expected.

In addition, as described above, the larger the distance C to the top face 14a of the protrusion portion 14 is, air flow in the vicinity of the fin 13 is disturbed.

For this reason, when the distance C to the top face 14a of the protrusion portion 14 is excessively large, there is a concern that a heat radiating performance may further deteriorate. In addition, when the distance C to the top face 14a of the protrusion portion 14 is excessively large, there is a concern that light-weighting of the lighting device for vehicle 1 may not be realized.

According to a knowledge which the inventors obtained, when the distance C to the top face 14a of the protrusion portion 14 is set to 4 mm or less, it is possible to improve a heat radiating performance, and realize light-weighting.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions. Moreover, above-mentioned embodiments can be combined mutually and can be carried out.

What is claimed is:

1. A lighting device for vehicle comprising:
a socket including a base portion, and a first protrusion portion which protrudes from one face of the base portion; and
a light emitting module which is provided at the first protrusion portion, and includes a light emitting element,
wherein the socket contains a heat conductive resin of which heat conductivity is 7 W/(m•K) or more and 11 W/(m•K) or less, and when a maximum dimension of the base portion in a direction orthogonal to a center axis of the lighting device for vehicle is set to A1 (mm), a maximum dimension of the first protrusion portion in a direction orthogonal to the center axis is set to A2 (mm), and power which is applied to the light emitting module is set to W (watt), (A1-A2)/W becomes 1.0 (mm/W) or more and 6.5 (mm/W) or less.

2. The device according to claim 1,
wherein the socket further includes a fin which is provided on a side opposite to a side of the base portion on which the first protrusion portion is provided, and a distance from a face of the base portion on the side opposite to the side on which the first protrusion portion is provided to a top face of the fin is set to 35 mm or less.

3. The device according to claim 1,
wherein the maximum dimension A1 is set to 40 mm or less.

4. The device according to claim 1,
wherein the power W is set to 1.0 W or more and 6.0 W or less.

5. The device according to claim 2,
wherein the socket further includes a second protrusion portion which is provided on a face of the base portion on the side opposite to the side on which the first protrusion portion is provided, and is bonded to the fin, and a distance from the face of the base portion on the side opposite to the side on which the first protrusion portion is provided to a top face of the second protrusion portion is set to 4 mm or less.

6. The device according to claim 2, further comprising:
a recessed portion which is open to the face of the base portion on the side opposite to the side on which the first protrusion portion is provided.

7. The device according to claim 6, further comprising:
a third protrusion portion which is provided inside the recessed portion, and is bonded to the fin.

8. The device according to claim 5,
wherein a plurality of the fins are provided, and the second protrusion portion is provided between one fin and another fin which is close to the one fin.

9. The device according to claim 8,
wherein the second protrusion portion is boned to at least any one of the one fin and another fin.

10. The device according to claim 5,
wherein the second protrusion portion is bonded to a base side of the fin.

11. The device according to claim 5,
wherein a direction in which the fin extends crosses a direction in which the second protrusion portion extends.

12. The device according to claim 5,
wherein a position of a top face of the second protrusion portion is located on the base portion side, rather than a position of the top face of the fin.

13. The device according to claim 5,
wherein the second protrusion portion includes a first face which intersects the fin, and a second face which stands face to face with the first face, and at least any one of the first face and the second face is inclined so that a distance between the first face and the second face becomes gradually short toward the top face of the second protrusion portion.

14. The device according to claim 13,
wherein a plurality of the second protrusion portions are provided, and the first faces of the plurality of second protrusion portions are inclined in the same direction.

15. The device according to claim 13,
wherein the plurality of second protrusion portions are provide, and the second faces of the plurality of second protrusion portions are inclined in the same direction.

16. The device according to claim 13,
wherein an inclining direction of the first face is opposite to an inclining direction of the second face.

17. The device according to claim 7,
wherein a plurality of the fins are provided, and the third protrusion portion is provided between the one fin and another fin which is close to the one fin.

18. The device according to claim 7,
wherein the third protrusion portion is bonded to the base side of the fin.

19. The device according to claim 17,
wherein the third protrusion portion is bonded to at least any one of the one fin and another fin.

20. The device according to claim 7,
wherein a position of a top face of the third protrusion portion is the same as a position of the top face of the second protrusion portion in a protruding direction of the third protrusion portion.
